(19) United States
(12) Patent Application Publication
(10) Pub. No.: US 2013/0316601 A1
(43) Pub. Date: Nov. 28, 2013

(54) BONDING CLIP

(71) Applicant: Cablofil, Inc., Mascoutah, IL (US)

(72) Inventors: Dallas Kellerman, Belleville, IL (US); Phillip Torre, Highland, IL (US)

(21) Appl. No.: 13/902,218

(22) Filed: May 24, 2013

Related U.S. Application Data
(60) Provisional application No. 61/651,378, filed on May 24, 2012.

(51) Int. Cl. H01R 13/24

(52) U.S. Cl. CPC H01R 13/245
USPC 439/884

(57) ABSTRACT

The disclosure relates to a bonding clip for making an electrical connection between metal pieces.

### FIELD OF THE DISCLOSURE

The present disclosure generally relates to a bonding clip for making an electrical connection in the joining of at least two metal pieces (e.g., two, three, four, or more, metal pieces).

### BACKGROUND OF THE DISCLOSURE

During the installation of a photovoltaic array composed of one or more photovoltaic modules, or solar panels, the arrays are installed onto a mounting structure. The individual photovoltaic modules typically have frames and structural mounting pieces which are generally made of anodized aluminum. The anodizing resists corrosion while also insulating the individual photovoltaic modules, preventing an electrical connection. In order to complete the electrical connection, the metal pieces must be bonded together, that is, joined thereby forming an electrically conductive path which ensures electrical continuity and safely conducts any imposed current. A need exists for improved devices for providing such electrical conductivity.

### SUMMARY OF THE DISCLOSURE

Among the various aspects of the present disclosure is a bonding clip for maintaining an electrical connection between a first metal piece and a second metal piece.

Briefly, therefore, the disclosure is directed to a bonding clip for maintaining an electrical connection in the joining of at least two metal pieces. The clip(s) is/are used in combination with a first metal piece, a second metal piece, and a fastener which holds the first metal piece to the second metal piece. In one embodiment, at least one of the first metal piece and the second metal piece is a photovoltaic module or solar panel (or portion thereof). In another embodiment, two bonding clips are used in combination with a first metal piece, a second metal piece, and a third metal piece; more preferably in this embodiment, at least two of the first, second, and third metal pieces are photovoltaic modules or solar panels (or portions thereof).

In general, the bonding clip includes, for example, a metal body portion, a first set of one or more teeth extending substantially orthogonally to the metal body portion in a first direction, and a second set of one or more teeth extending substantially orthogonally to the metal body portion in a second direction opposite the first direction, wherein the first set of one or more teeth contact a first metal piece and the second set of one or more teeth contact a second metal piece when the metal body portion is placed between the first and second metal pieces.

When tightened, the first set of one or more teeth embed into the first metal piece, thereby making electrical contact with the first metal piece, and the second set of one or more teeth embed into the second metal piece, thereby making electrical contact with the second metal piece, thereby in turn making electrical connection between the first metal piece and the second metal piece. The height of the first and second sets of teeth can be varied according to the properties of the metal pieces (e.g., the thickness of anodizing) to ensure that the first and second sets of teeth will fully penetrate the various metal pieces. Additionally, in some embodiments, a desired electrical resistance can be achieved by varying the number and shape of the first and second sets of teeth.

In certain preferred embodiments, the bonding clip is connected to the first and/or second metal pieces in such a manner that the fastener is substantially adjacent to, but does not immediately connect with or penetrate, the bonding clip. In such embodiments, therefore, the bonding clip lacks any clearance hole or opening for accepting or otherwise cooperating with the fastener. In particularly preferred embodiments, two or more bonding clips are used for cooperating with at least a first metal piece and optionally a second metal piece.

In certain other embodiments, the bonding clip may be affixed to the first metal piece during or after manufacture of the first metal piece such that the bonding clip is secured to the first metal piece prior to the installation or joining of the first metal piece and the second metal piece.

Other objects and features will be in part apparent and in part pointed out hereinafter.

### BRIEF DESCRIPTION OF THE DRAWINGS

The above mentioned and other features of the present disclosure and the manner of obtaining them will become more apparent and the disclosure will be best understood by reference to the following description of embodiments of the disclosure taken in conjunction with the accompanying drawings, in which like numerals refer to like parts, and in which:

FIG. 1A is a perspective view of a bonding clip according to one embodiment of the present disclosure as described herein;

FIG. 1B is a left side elevation view of a bonding clip according to one embodiment of the present disclosure as described herein;

FIG. 1C is a top plan view of a bonding clip according to one embodiment of the present disclosure as described herein;

FIG. 1D is a front elevation view of a bonding clip according to one embodiment of the present disclosure as described herein;

FIG. 1E is a front elevation partial view including an enlarged view of a tooth in a bonding clip according to one embodiment of the present disclosure as described herein;

FIG. 2A is a perspective view of a bonding clip having flanges according to one embodiment of the present disclosure as described herein;

FIG. 2B is a left side elevation view of a bonding clip having flanges according to one embodiment of the present disclosure as described herein;

FIG. 2C is a top plan view of a bonding clip having flanges according to one embodiment of the present disclosure as described herein;

FIG. 2D is a front elevation view of a bonding clip having flanges according to one embodiment of the present disclosure as described herein;

FIG. 2E is a front elevation partial view including an enlarged view of a tooth in a bonding clip having flanges according to one embodiment of the present disclosure as described herein;

FIG. 3A is a perspective view of a bonding clip having a semi-cylindrical retaining tab according to one embodiment of the present disclosure as described herein;

FIG. 3B is a left side elevation view of a bonding clip having a semi-cylindrical retaining tab according to one embodiment of the present disclosure as described herein;

FIG. 3C is a top plan view of a bonding clip having a semi-cylindrical retaining tab according to one embodiment of the present disclosure as described herein;

FIG. 4A is a perspective view of a bonding clip having a semi-cylindrical retaining tab according to one embodiment of the present disclosure as described herein;

FIG. 4B is a left side elevation view of a bonding clip having a semi-cylindrical retaining tab according to one embodiment of the present disclosure as described herein;

FIG. 4C is a top plan view of a bonding clip having a semi-cylindrical retaining tab according to one embodiment of the present disclosure as described herein;

FIG. 4D is a left side elevation partial view including an enlarged view of teeth in a bonding clip having a semi-cylindrical retaining tab according to one embodiment of the present disclosure as described herein;

FIGS. 5A and 5B are partially exploded views of a first metal piece and a bonding clip having flanges according to one embodiment of the present disclosure as described herein;

FIGS. 6A and 6B are partially exploded views of a first metal piece and a bonding clip having a semi-cylindrical retaining tab according to one embodiment of the present disclosure as described herein;

FIG. 7 is a perspective view of two bonding clips in combination with a first metal piece, a T-bolt, spring and a keeper according to one embodiment of the present disclosure as described herein;

FIG. 8 is a perspective view of two bonding clips in combination with a first metal piece and an exemplary fastener according to one embodiment of the present disclosure as described herein;

FIG. 9 is a partially exploded view of two bonding clips in combination with a first metal piece and an exemplary fastener according to one embodiment of the present disclosure as described herein.

Additional advantages and features will become apparent to those skilled in the art from this disclosure, including the following detailed description. While the inventions are described herein with reference to implementations thereof, the inventions are not limited to those implementations. Those of ordinary skill in the art having access to the teachings herein will recognize additional applications, modifications and implementations, which are within the scope of the disclosure and claimed herein and with respect to which the invention could be of utility.

### DETAILED DESCRIPTION

The accompanying Figures and this description depict and describe embodiments of a bonding clip and related structures and systems in accordance with the present disclosure, and features and components thereof. It should also be noted that any references herein to front and back, right and left, top and bottom and upper and lower are intended for convenience of description, not to limit the present disclosure or its components to any one positional or spatial orientation.

The present disclosure relates to a bonding clip for making electrical connection between metal pieces, generally identified as structure 10 in the related Figures.

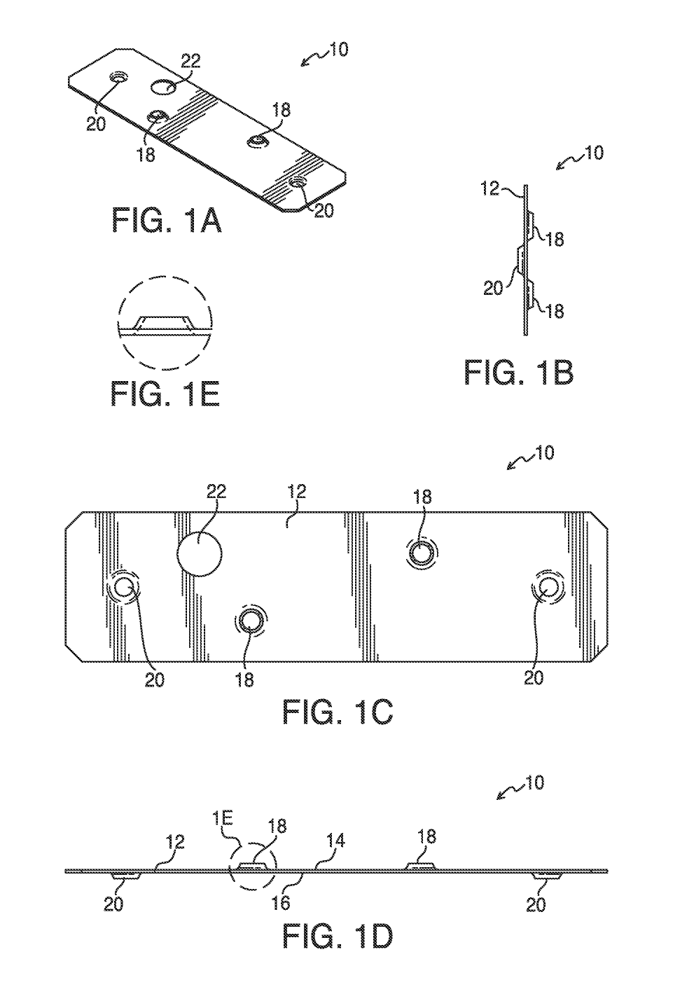

As shown in FIGS. 1A-1D, bonding clip 10 includes a substantially rectangular metal body portion 12. Accordingly, the substantially rectangular metal body portion has a first and a second long side portion and a first and a second short side portion, wherein the first and second long side portions each have a first dimension measured in a first direction and the first and second short side portions each have a second dimension measured in a second direction substantially orthogonal to the first direction and wherein the first dimension is longer than the second dimension. The metal body portion 12 further includes a substantially planar first surface 14 and a substantially planar second surface 16 opposite the first surface 14.

In general, the bonding clip 10 described herein may be constructed of any suitable material that is suitable for conducting electricity and is preferably corrosion resistant. For example, the bonding clip and/or components thereof may be formed of various electrically conductive materials including, but not limited to, silver, copper, gold, aluminum, tungsten, zinc, nickel, iron, platinum, tin, titanium, stainless steel, and alloys thereof. In one embodiment, for example, bonding clip 10 may be steel or an alloy thereof (e.g., stainless steel alloys). In another embodiment, for example, bonding clip 10 may be silver or an alloy thereof. In yet another embodiment, for example, bonding clip 10 may be titanium or an alloy thereof. In yet another embodiment, for example, bonding clip 10 may be copper or an alloy thereof.

Bonding clip 10 may also be coated with a thin coating of an additional material to increase the hardness, e.g., relative to the first and/or second metal pieces to which the bonding clip is to be bonded. In one embodiment, for example, the coating may be chromium. In another embodiment, for example, the coating may be titanium nitride. In yet another embodiment, the boding clip includes an anodized coating.

The bonding clip 10 includes a first set of one or more teeth 18 extending substantially orthogonally from first surface 14 in a first direction, and a second set of one or more teeth 20 extending substantially orthogonally from second surface 16 in a second direction. As can be seen in the various figures, the first and second sets of teeth extend in directions opposite one another; that is, the second direction is substantially opposite the first direction. It will be understood that any number of teeth in the first and/or second sets of teeth can be employed. In some embodiments, a desired electrical resistance can be achieved by varying the number and shape of the first and second sets of teeth. In certain of the illustrated embodiments, for example, a single tooth 18 extends from first surface 14 in a first direction while two teeth 20 extend from second surface 16 in a second direction opposite the first direction.

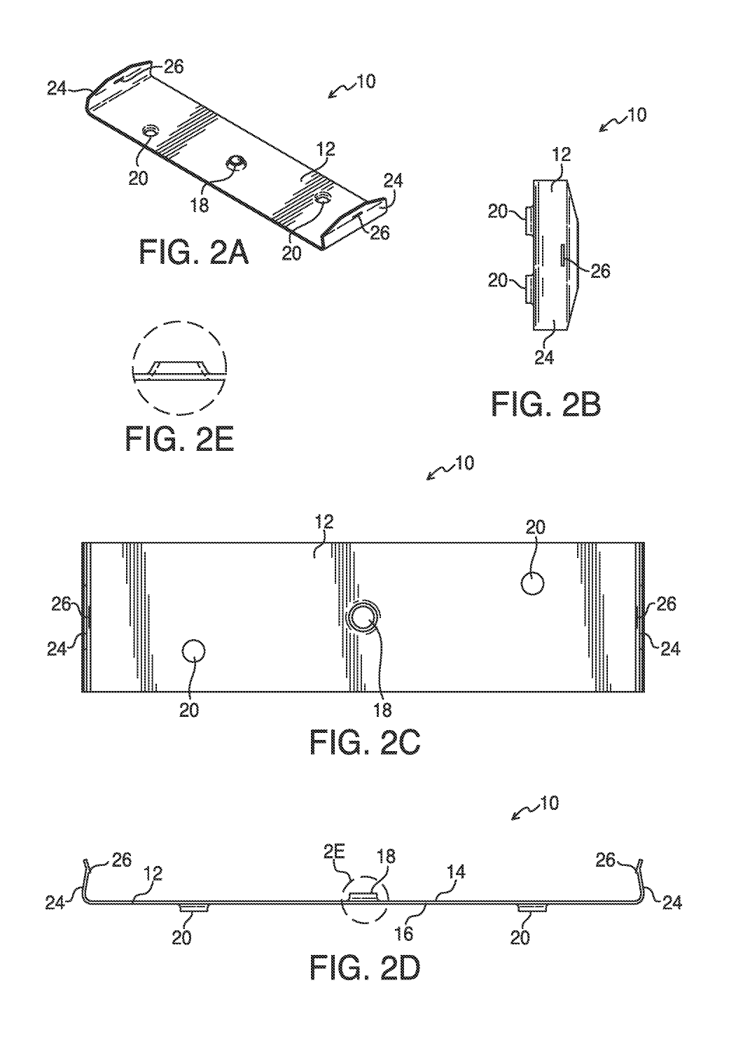

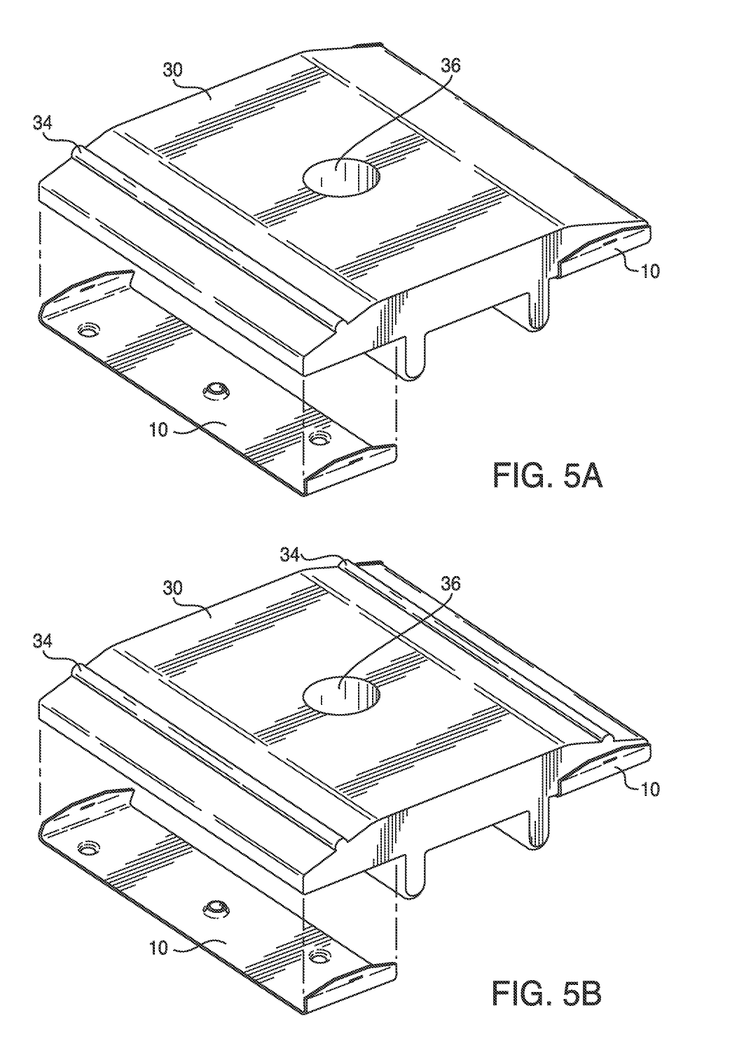

As shown in the various figures, first set of teeth 18 and second set of teeth 20 are generally circular in cross-sectional shape and may be punched out of metal body portion 12. Because the first set of teeth 18 and second set of teeth 20 extend substantially orthogonally to metal body portion, they enable greater mechanical contact between metal pieces (see, e.g., FIGS. 5A-9), resulting in greater electrical contact. As illustrated in FIG. 1E, for example, the teeth preferably have a cross-sectional height greater than their cross-sectional thickness. Additionally, in certain embodiments, the teeth in cross-section are asymmetrical with respect to the perpendicular (see, e.g., FIGS. 1E and 2E). Accordingly, the teeth have a very rigid structure which allows easy penetration into the metal pieces to which they are bonded. Although the illustrated sets of teeth 18 and 20 are substantially circular, it should be readily apparent to one skilled in the art that other tooth shapes (e.g., square, triangular, or other polygonal cross-sectional shapes) can be formed into metal body portion 12. Additionally, while it is envisioned that in some embodiments, first set of teeth 18 and second set of teeth 20 are formed by punching metal body portion 12, it should be readily apparent to one skilled in the art that, in other embodiments, other methods such as machining, casting, pressure forming, and photochemical machining may be used to form first set of teeth 18 and/or second set of teeth 20.

The position of the various teeth on the first and/or second surfaces 14 and 16 can also vary. In one particular embodiment, illustrated in FIGS. 1A and 1C, for example, a single first tooth 18 is located substantially in the center of metal body portion 12, while a set of two second teeth 20 are located off center, closer to the opposing edges of the first and second long side portions of metal body portion 12. It will be understood that the desired positioning of the first set of teeth 18 and/or second set of teeth 20 may depend upon the shape, structure, and/or composition of the metal pieces with which the bonding clip is to be used. Multiple, or single, teeth in first and second sets of teeth 18 and 20 may also be employed as noted above.

The height of the teeth extending away from the first and second surfaces can additionally, or alternatively, vary, e.g., depending upon the shape, structure, and/or composition of the metal pieces with which the bonding clip is to be used. Typically, first set of teeth 18 and/or second set of teeth 20 extend in a range between about 0.005 inches to about 0.05 inches from first surface 14 and second surface 16, respectively. In one embodiment, for example, first set of teeth 18 and/or second set of teeth 20 extend about 0.005 inches from first surface 14 and second surface 16, respectively. In another embodiment, for example, first set of teeth 18 and/or second set of teeth 20 extend about 0.01 inches from first surface 14 and second surface 16, respectively. In another embodiment, for example, first set of teeth 18 and/or second set of teeth 20 extend about 0.015 inches from first surface 14 and second surface 16, respectively. In another embodiment, for example, first set of teeth 18 and/or second set of teeth 20 extend about 0.02 inches from first surface 14 and second surface 16, respectively. In another embodiment, for example, first set of teeth 18 and/or second set of teeth 20 extend about 0.025 inches from first surface 14 and second surface 16, respectively. In another embodiment, for example, first set of teeth 18 and/or second set of teeth 20 extend about 0.03 inches from first surface 14 and second surface 16, respectively. In another embodiment, for example, first set of teeth 18 and/or second set of teeth 20 extend about 0.035 inches from first surface 14 and second surface 16, respectively. In another embodiment, for example, first set of teeth 18 and/or second set of teeth 20 extend about 0.04 inches from first surface 14 and second surface 16, respectively. In another embodiment, for example, first set of teeth 18 and/or second set of teeth 20 extend about 0.045 inches from first surface 14 and second surface 16, respectively. In another embodiment, for example, first set of teeth 18 and/or second set of teeth 20 extend about 0.05 inches from first surface 14 and second surface 16, respectively. In still other embodiments, the height of the first set of teeth 18 and second set of teeth 20 can vary relative to one other; that is, for example, first set of teeth 18 can extend from first surface 14 further than second set of teeth 20 extends from second surface 16, or vice versa.

As noted above, the shape of the teeth extending away from the first and second surfaces can additionally, or alternatively, vary, e.g., depending upon the shape, structure, and/or composition of the metal pieces with which the bonding clip is to be used. For example, where first set of teeth 18 and/or second set of teeth 20 are substantially circular in cross-sectional shape, first set of teeth 18 and/or second set of teeth 20 range in diameter from about 0.04 inches to about 0.075 inches. In one embodiment, for example, first set of teeth 18 and/or second set of teeth 20 have a diameter of about 0.04 inches. In another embodiment, for example, first set of teeth 18 and/or second set of teeth 20 have a diameter of about 0.045 inches. In another embodiment, for example, first set of teeth 18 and/or second set of teeth 20 have a diameter of about 0.05 inches. In another embodiment, for example, first set of teeth 18 and/or second set of teeth 20 have a diameter of about 0.055 inches. In another embodiment, for example, first set of teeth 18 and/or second set of teeth 20 have a diameter of about 0.06 inches. In another embodiment, for example, first set of teeth 18 and/or second set of teeth 20 have a diameter of about 0.065 inches. In another embodiment, for example, first set of teeth 18 and/or second set of teeth 20 have a diameter of about 0.07 inches. In another embodiment, for example, first set of teeth 18 and/or second set of teeth 20 have a diameter of about 0.075 inches. In still other embodiments, the diameter of the first set of teeth 18 and second set of teeth 20 can vary relative to one other; that is, for example, first set of teeth 18 can have a greater diameter than second set of teeth 20 extends from second surface 16, or vice versa.

In one particular embodiment of the present disclosure illustrated in FIGS. 2A-2D, one or more flanges 24 are included at the short edges of metal body portion 12. Each flange 24 extends at an angle (e.g., about) 85-90° with respect to and away from first surface 14. In this way, flange(s) 24 provide additional surfaces to bond or otherwise secure to a metal piece, e.g., a first or second metal piece (see, e.g., FIGS. 5A and 5B). In certain embodiments, flange(s) 24 may further include projection 26 which may be formed, for example, by punching through each flange 24. When present, each projection 26, in combination with each flange 24, can provide a more secure attachment to the metal piece with which it is used.

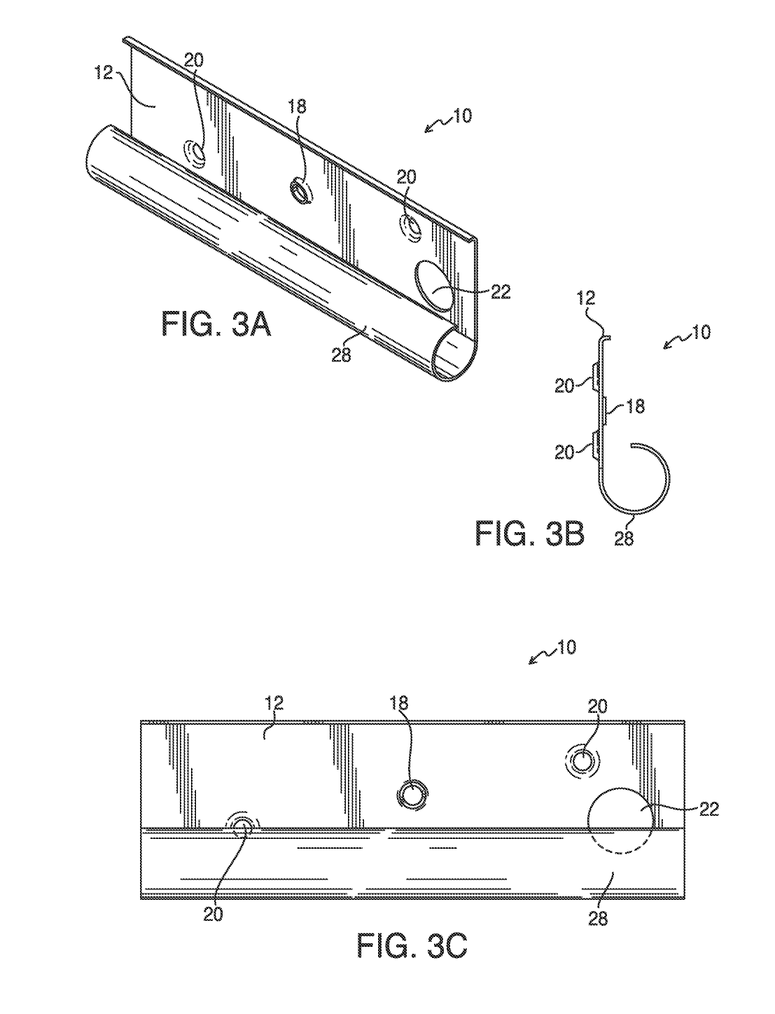

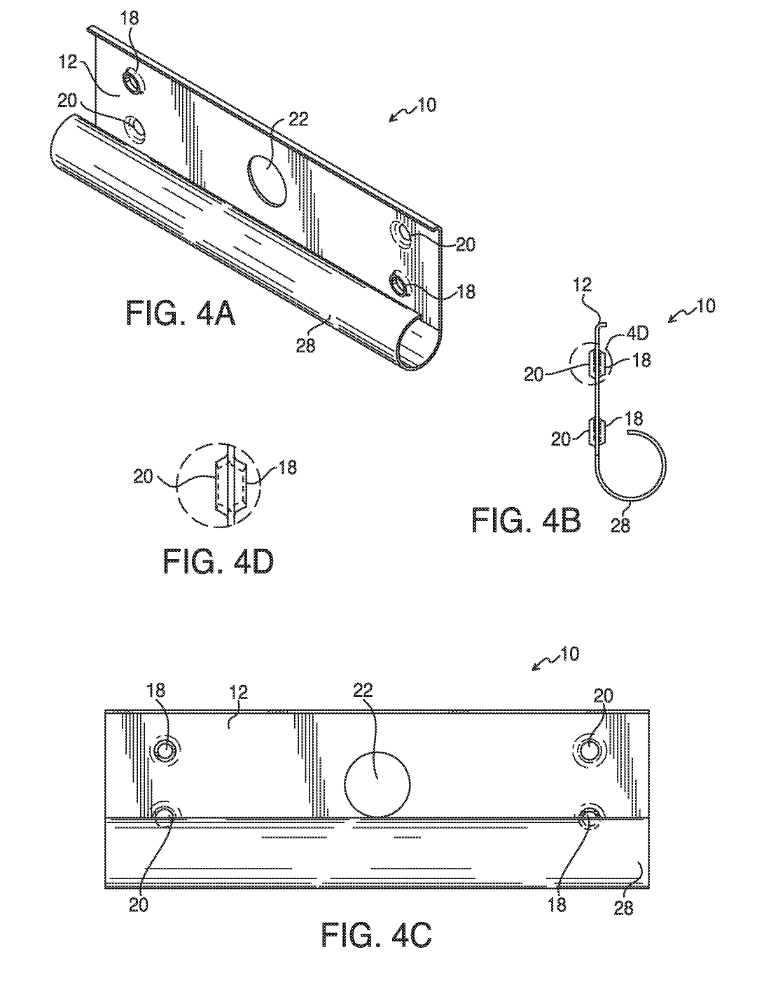

As shown in FIGS. 1A, 2C, 3A, 3C, 4A, and 4C, bonding clip 10 may include a locating hole 22 that can be used to orient bonding clip 10 during manufacture. The position of the locating hole within the metal body portion can vary (see, e.g., FIGS. 3A, 3C, 4A, and 4C), and this hole generally does not include extending portions similar to first set of teeth 18 and second set of teeth 20.

In another particular embodiment of the present disclosure illustrated in FIGS. 3A-3C, the bonding clip 10 may further include a retaining tab 28 for engaging a corresponding portion of a first metal piece. In the illustrated embodiments, the retaining tab 28 has a generally semi-cylindrical structure and has a hollow region and a central axis running parallel to the first direction. As shown, semi-cylindrical retaining tab 28 is open on the first and second short side portions of metal body portion 12. FIGS. 4A-4C are substantially similar to FIGS. 3A-3C, except that the former illustrate that the various first and second teeth 18 and 20 can be differently oriented and differ in number, as can the position of the locating hole 22.

Referring now to FIGS. 5A and 5B, attachment of the bonding clip 10 to a first metal piece 30 is shown. In FIGS. 5A and 5B, in one embodiment of the present disclosure, first metal piece 30 optionally includes one or more rib(s) 34 extending the length of one (or more) side(s) of first metal piece 30, for use in connection with the retaining tab 28 (not shown). First metal piece 30 further includes one or more hole(s) 36 which is adapted to accept a fastener (not shown), for example, for use in installing photovoltaic modules. Additionally, FIGS. 5A and 5B illustrate that bonding clip 10 can be further attached to first metal piece 30 via flanges 24.

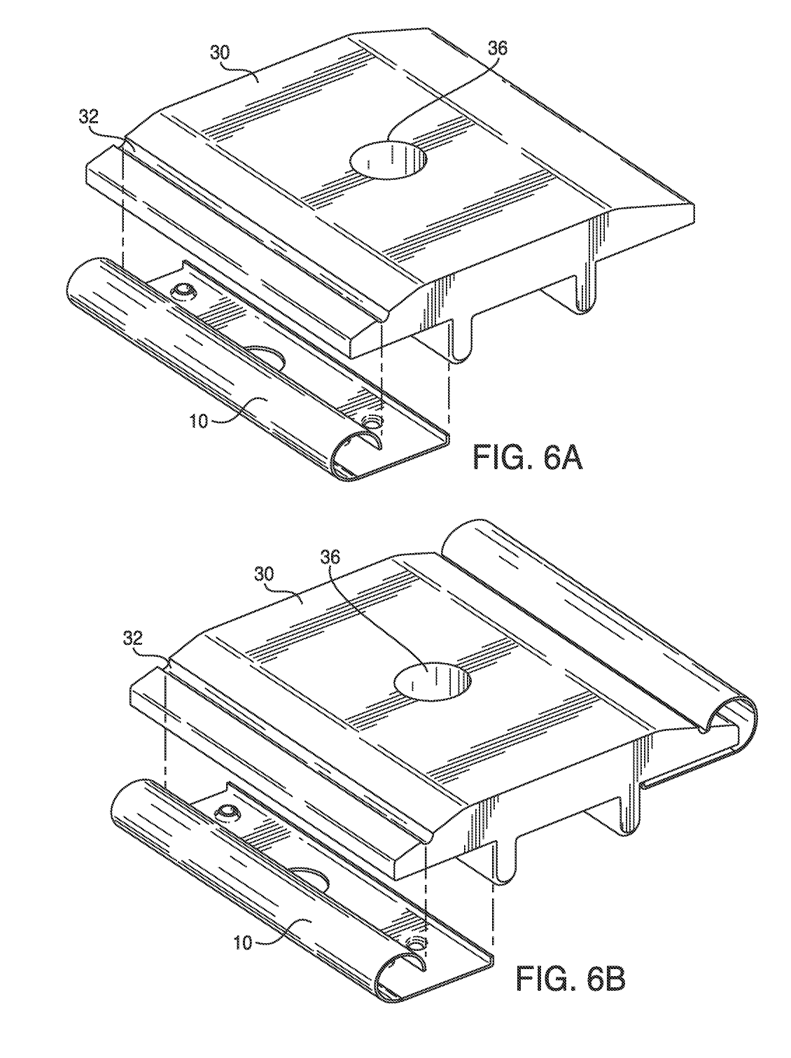

FIGS. 6A and 6B show the attachment of an alternative bonding clip 10 to a first metal piece 30. In FIGS. 6A and 6B, in one embodiment of the present disclosure, first metal piece optionally includes one or more groove(s) 32 extending the length of one (or more) side(s) of first metal piece 30, for use in connection with the retaining tab 28. As shown, retaining tab 28 is seated in groove 32 thereby holding bonding clip 10 in place. It will be understood that retaining tab 28 may also cooperate with the rib(s) 34 shown in FIGS. 5A and 5B, such that the retaining tab is clipped on the inner side of the rib thus holding bonding clip 10 in place.

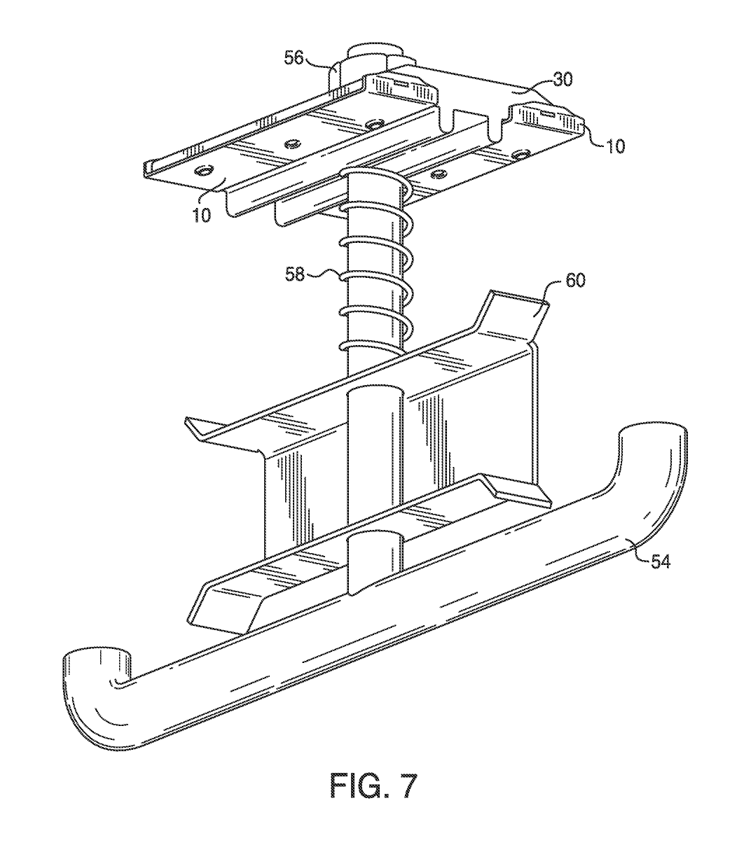

In FIG. 7, an embodiment of a mounting assembly including the bonding clip 10 is illustrated. In this particular embodiment, the first metal piece 30 and the second metal piece (not shown) are installed using a T-bolt and keeper type fastener 54, wherein the fastener includes a vertical portion orthogonal to and located near the midpoint of a horizontal portion. A portion of the vertical portion of fastener 54 may be threaded to accept a nut 56. A bracket 60 for accepting the vertical portion is also provided. The vertical portion may also include a spring 58 for providing tension to the assembly. Second metal pieces (not shown), such as photovoltaic modules, may be positioned between the bonding clips 10 located on the first metal piece 30 and the assembly tightened to engage the various teeth in the first and second metal pieces thus facilitating the electrical connection between the various components. Although the bonding clip of FIGS. 2A-2D is illustrated in FIG. 7, it will be understood that any bonding clip described herein, for example, those of FIGS. 1A-1D and/or FIGS. 3A-4D, can be employed with the first metal piece 30 and the T-bolt and keeper type fastener 54 shown in FIG. 7.

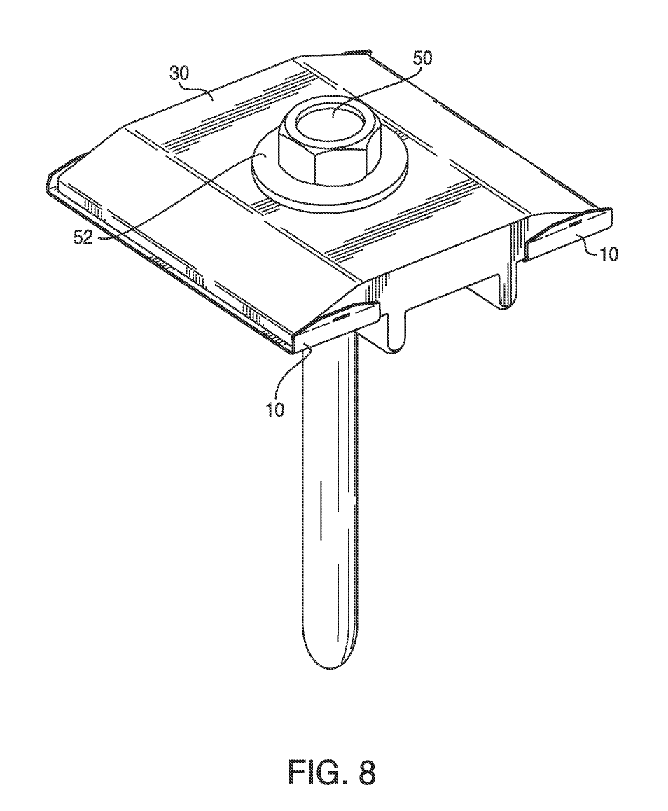

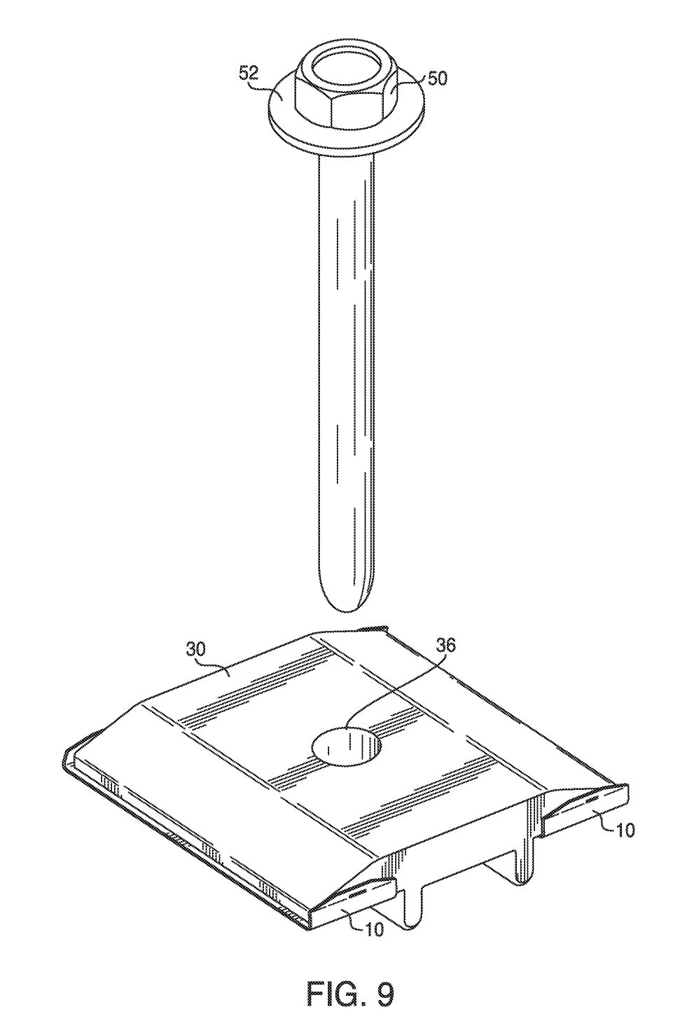

FIGS. 8 and 9 illustrate yet another embodiment of a mounting assembly. In this particular embodiment, the fastener includes a bolt 50 which is inserted through hole 36 of the first metal piece 30 and a washer 52 is optionally placed between the head of bolt 50 and first metal piece 30. Similar to FIG. 7, second metal pieces (not shown), such as photovoltaic modules, may be positioned between the bonding clips 10 and the first metal piece 30 and the assembly tightened (e.g., using a threaded bolt and cooperating nut) to engage the various teeth in the first and second metal pieces thus facilitating the electrical connection between the various components. Although the bonding clip of FIGS. 2A-2D is illustrated in FIGS. 8 and 9, it will be understood that any bonding clip described herein, for example, those of FIGS. 1A-1D and/or FIGS. 3A-4D, can be employed with the first metal piece 30 and the bolt 50 shown in FIGS. 8-9.

While specific embodiments have been shown and described, many variations are possible. The particular shape of the various components including all horizontal and vertical orientations, dimensions and thicknesses may be changed as desired to suit the particular metal pieces and fasteners with which the invention is used. Additionally, the types of fasteners used may be changed as desired to suit the metal pieces with which the invention is used. The material and its configuration and number of components segments may vary although certain preferred embodiments are shown and described. The terms, descriptions and figures used herein are set forth by way of illustration only and are not meant as limitations. Those of ordinary skill in the art will recognize that many variations are possible within the scope of the invention, which is intended to be defined by the disclosure herein and their equivalents, in which all terms are meant in their broadest reasonable sense unless otherwise indicated.

In this specification, the terms “about” and “around” are to signify that in one embodiment, the respective exact value is designated, while in another embodiment, the approximate value is designated. Thus, for example, “at least about 1,000” may, in one embodiment, be interpreted to mean “at least 1,000” and, in another embodiment, be interpreted to mean “at least approximately 1,000.” The terms “comprising,” “including,” and “having,” as used in the claims and specification herein, shall indicate an open group that may include other elements not specified. The term “consisting essentially of,” as used in the claims and specification herein, shall indicate a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “preferably,” “preferred,” “prefer,” “optionally,” “may,” and like terms are used in the specification to indicate that an item, condition, or step being referred to is an optional (not required) feature of the invention.

Having described the invention in detail, it will be apparent that modifications and variations are possible without departing the scope of the invention defined in the appended claims. Furthermore, it should be appreciated that all examples and illustrated embodiments in the present disclosure are provided as non-limiting examples.

What is claimed is:

1. A bonding clip for maintaining an electrical connection between a first metal piece and a second metal piece wherein a fastener holds the first metal piece to the second metal piece, the bonding clip comprising a substantially rectangular metal body portion, a first set of one or more teeth extending substantially orthogonally to the metal body portion in a first direction, and a second set of one or more teeth extending substantially orthogonally to the metal body portion in a second direction opposite the first direction, wherein the first set of one or more teeth contact a first metal piece and the second set of one or more teeth contact a second metal piece when the metal body portion is placed between the first and second metal pieces.

2. The bonding clip of claim 1, further comprising at least one flange positioned at a side region of the metal body portion and extending at an angle to the first or second surface.

3. The bonding clip of claim 2, comprising at least two flanges positioned at opposing side regions of the metal body portion and extending at an angle to the first or second surface.

4. The bonding clip of claim 2, wherein the flange further comprises a projection for securing a portion of the flange to the first metal piece.

5. The bonding clip of claim 3, wherein the flange further comprises a projection for securing a portion of the flange to the first metal piece.

6. The bonding clip of claim 1, wherein a retaining tab for mating with the first metal piece extends from a side region of the metal body portion for engaging a corresponding rib or groove on the first metal piece.

7. An assembly comprising a first metal piece, a second metal piece, a fastener, and the bonding clip of claim 1, wherein the fastener holds the first metal piece to the second metal piece and the bonding clip maintains an electrical connection between the first metal piece and the second metal piece.

8. The assembly of claim 7, wherein the fastener comprises a T-bolt, spring, and keeper arrangement.

9. The assembly of claim 7, wherein the fastener comprises a threaded bolt.

10. A method for securing a first metal piece and a second metal piece maintaining an electrical connection between the first metal piece and the second metal piece, the method comprising positioning the bonding clip of claim 1 between the first metal piece and the second metal piece and tightening the positioned pieces with a fastener.
